(19) United States
(12) Patent Application Publication
(10) Pub. No.: US 2026/0304548 A1
(43) Pub. Date: Oct. 1, 2026

(54) METHOD, APPARATUS, DEVICE AND STORAGE MEDIUM FOR COMMUNICATION CONTROL

(71) Applicant: Beijing Zitiao Network Technology Co., Ltd., Beijing (CN)

(72) Inventors: Bin Hu, Beijing (CN); Guojing Liu, Beijing (CN)

(21) Appl. No.: 19/428,045

(22) Filed: Dec. 19, 2025

(30) Foreign Application Priority Data
Mar. 26, 2025 (CN) 202510364641.3

(51) Int. Cl. H04W 76/28; H04W 76/19

(52) U.S. Cl. CPC H04W 76/28; H04W 76/19

(57) ABSTRACT

A method includes: determining a state of connected mode discontinuous reception (CDRX) between a terminal device and a network device; determining, in response to the state indicating that the CDRX is in an unconfigured state, whether to trigger a reconnection based on at least one of a duration of the unconfigured state of the CDRX or a data transceiving condition of the terminal device; and triggering, in response to determining to trigger the reconnection, a reconnection operation between the terminal device and the network device.

### CROSS-REFERENCE

The present application claims priority to Chinese Patent Application No. 202510364641.3, filed on Mar. 26, 2025, and entitled “METHOD, APPARATUS, DEVICE AND STORAGE MEDIUM FOR COMMUNICATION CONTROL”, the entirety of which is incorporated herein by reference.

### FIELD

Example embodiments of the present disclosure generally relate to the field of computers, and in particular, to a method, an apparatus, a device, and a computer-readable storage medium for mobile communication.

### BACKGROUND

With the development of communication technologies, a user may communicate with a network device of an operator through a terminal device, so as to obtain various services provided by the operator and access a data network via the network device. In a process of the terminal device communicating with the network device of the operator, power management may be performed on the terminal device based on a power management technology, to reduce power consumption of the terminal device. The power management technology may include, for example, a connected mode discontinuous reception (CDRX) technology.

### SUMMARY

In a first aspect of the present disclosure, a communication control method is provided. The method includes: determining a state of connected mode discontinuous reception (CDRX) between a terminal device and a network device; determining, in response to the state indicating that the CDRX is in an unconfigured state, whether to trigger a reconnection based on at least one of a duration of the unconfigured state of the CDRX or a data transceiving condition of the terminal device; and triggering, in response to determining to trigger the reconnection, a reconnection operation between the terminal device and the network device.

In a second aspect of the present disclosure, an apparatus for communication control is provided. The apparatus includes: a state determination module configured to determine a state of CDRX between a terminal device and a network device; a reconnection determination module configured to determine, in response to the state indicating that the CDRX is in an unconfigured state, whether to trigger a reconnection based on at least one of a duration of the unconfigured state of the CDRX or a data transceiving condition of the terminal device; and a reconnection operation triggering module configured to trigger, in response to determining to trigger the reconnection, a reconnection operation between the terminal device and the network device.

In a third aspect of the present disclosure, an electronic device is provided. The device includes at least one processor; and at least one memory. The at least one memory is coupled to the at least one processor, and stores instructions executable by the at least one processor. The instructions, when executed by the at least one processor, causes the device to perform the method of the first aspect.

In a fourth aspect of the present disclosure, a computer-readable storage medium is provided. The computer-readable storage medium stores a computer program executable by a processor to implement the method of the first aspect.

In a fifth aspect of the present disclosure, a computer program product is provided. The computer program product is tangibly stored in a computer storage medium and includes computer-executable instructions. The computer-executable instructions, when executed by a device, causes the device to perform the method of the first aspect.

It should be understood that content described in this summary is not intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the drawings and with reference to the following detailed description. In the drawings, the same or similar reference symbols refer to the same or similar elements, where:

FIG. 1 shows a schematic diagram of an example environment in which the embodiments of the present disclosure may be implemented;

FIG. 2 to FIG. 3 show flowcharts of example communication control processes according to some embodiments of the present disclosure;

FIG. 4 shows a flowchart of an example process of determining to trigger a reconnection according to some embodiments of the present disclosure;

FIG. 5 shows a flowchart of an example process of communication control according to some embodiments of the present disclosure;

FIG. 6 shows a schematic structural block diagram of an example apparatus for communication control according to some embodiments of the present disclosure; and

FIG. 7 shows a block diagram of an electronic device capable of implementing multiple embodiments of the present disclosure.

### DETAILED DESCRIPTION OF EMBODIMENTS

The embodiments of the present disclosure will be described in more detail below with reference to the drawings. Although some embodiments of the present disclosure are shown in the drawings, it should be understood that the present disclosure may be implemented in various forms, and should not be interpreted as being limited to the embodiments set forth herein. Instead, these embodiments are provided for a more thorough and complete understanding of the present disclosure. It should be understood that the drawings and embodiments of the present disclosure are only for example purposes, and are not intended to limit the scope of protection of the present disclosure.

It should be noted that the titles of any sections/subsections provided herein are not restrictive. Various embodiments are described throughout this article, and any type of embodiments may be included under any section/subsection. In addition, the embodiments described in any section/subsection may be combined with any other embodiments described in the same section/subsection and/or different section/subsection in any manner.

In the description of the embodiments of the present disclosure, the term “include/comprise” and similar terms thereof should be understood as open-ended inclusions, that is, “include/comprise but not limited to”. The term “based on” should be understood as “at least partially based on”. The term “one embodiment” or “the embodiment” should be understood as “at least one embodiment”. The term “some embodiments” should be understood as “at least some embodiments”. Other explicit and implicit definitions may also be included below. The terms “first”, “second”, etc. may refer to different or same objects. Other explicit and implicit definitions may also be included below.

The embodiments of the present disclosure may involve user data, data acquisition and/or data use, etc. These aspects all follow the corresponding laws, regulations and related provisions. In the embodiments of the present disclosure, all data collection, acquisition, processing, machining, forwarding, use, etc. are performed on the premise that the user is aware and confirms. Correspondingly, when implementing the embodiments of the present disclosure, the user should be informed of the type, range of use, use scenarios, etc., of data or information that may be involved, and the authorization of the user should be obtained, through appropriate means according to relevant laws and regulations. A specific manner of informing and/or authorizing may be changed according to actual situations and application scenarios, and the scope of the present disclosure is not limited in this regard.

If the solutions in this specification and the embodiments involve personal information processing, the processing will be performed on the premise that there is a legal basis (for example, the consent of the personal information subject is obtained, or it is necessary for the performance of a contract, etc.), and the processing will only be performed within the scope of regulations or agreements. If the user refuses to process personal information other than the necessary information required for the basic functions, it will not affect the user's use of the basic functions.

As used herein, the term “communication network” refers to a network that follows any suitable communication standard, such as new radio (NR), long term evolution (LTE), LTE-advanced (LTE-A), wideband code division multiple access (WCDMA), high speed packet access (HSPA), narrow band internet of things (NB-IoT), and so on. In addition, the communication between the terminal device and the network device in the communication network may be performed according to any suitable generation of communication protocols, including but not limited to, first generation (1G), second generation (2G), 2.5G, 2.75G, third generation (3G), fourth generation (4G), 4.5G, fifth generation (5G), sixth generation (6G) communication protocols and/or any other protocols currently known or to be developed in the future. The example embodiments of the present disclosure may be applied to various communication systems, including but not limited to, terrestrial communication systems, non-terrestrial communication systems, or a combination thereof. Considering the rapid development of the communication field, there will of course also be future types of communication technologies and systems that may be used to implement the present disclosure. It should not be seen as limiting the scope of the present disclosure to only the aforementioned systems.

As used herein, the term “network device” refers to a node in a communication network, through which a terminal device accesses the network and receives services therefrom. Depending on the applied terminology and technology, a network device may refer to a base station (BS) or an access point (AP), such as a NodeB (NodeB or NB), an evolved NodeB (eNodeB or eNB), an NR NB (also referred to as a gNB), a remote radio unit (RRU), a radio head (RH), a remote radio head (RRH), a relay, an integrated access and backhaul (IAB) node, a low power node such as a femto, a pico, and so on.

As used herein, the term “terminal device” refers to any terminal device capable of wireless communication. By way of example, rather than limitation, a terminal device may also be referred to as a network device, a user equipment (UE), a user station (SS), a portable user station, a mobile station (MS), or an access terminal (AT). The terminal device may include, but is not limited to, a mobile phone, a cellular phone, a smart phone, a voice over IP (VoIP) phone, a wireless local loop phone, a tablet computer, a wearable terminal device, a personal digital assistant (PDA), a portable computer, a desktop computer, an image capture terminal device such as, for example, a digital camera, a game terminal device, a music storage and playback device, a vehicle-mounted wireless terminal device, a wireless endpoint, a mobile station, a laptop embedded device (LEE), a laptop mounted device (LME), a universal serial bus (USB) dongle, a smart device, a wireless customer premise equipment (CPE), an internet of things (IoT) device, a watch or other wearable device, a head-mounted display (HMD), a vehicle, a drone, a medical device and applications (e.g., remote surgery), an industrial device and applications (e.g., robots and/or other wireless devices operating in an industrial and/or automated processing chain environment), a consumer electronic device, a device running on a commercial and/or industrial wireless network, and so on. The terminal device may correspond to a mobile terminal (MT) part (e.g., a relay node) of an IAB node. In the following description, the terms “terminal device”, “network device”, “terminal”, “user equipment”, and “UE” may be used interchangeably.

As mentioned above, currently, in long term evolution (LTE) and 5G communication systems, the CDRX technology has been widely used to manage the power of the terminal device in communication control. The CDRX technology is used to save power consumption of the terminal device when the terminal device is in a communication connection state. Based on the CDRX technology, even when the terminal device is in the communication connection state with the network device (for example, performing data transceiving intermittently), the baseband transceiver of the terminal device may sleep and turn off radio frequency transceiving, thereby reducing the power consumption of the terminal device.

However, in some communication scenarios, the CDRX mode between the terminal device and the network device may be in an unconfigured state (or referred to as invalid). At this time, if there is still frequent data transceiving between the terminal device and the network device, the terminal device will maintain the communication connection state without the CDRX configured. As a result, the baseband transceiver of the terminal device will not sleep or turn off the radio frequency, which in turn leads to relatively large power consumption of the terminal device. An example communication scenario may be as follows. In a scenario where the data transceiving activity of the terminal device is high (for example, data is transceived at a high throughput rate, etc.), the network device of the operator may turn off the CDRX mode in order to provide excellent data transmission performance. After the scenario with high data transceiving activity ends, the network device of the operator may fail to reconfigure the CDRX due to some situations (such as configuration errors, etc.), resulting in the current radio resource control (RRC) connection continuing to be in a state without the CDRX configured. In this case, if the terminal device still has a low data transceiving activity, the previous RRC connection will be in a long connection state, which will seriously consume the power of the terminal device.

It should be understood that only example communication scenarios to which the embodiments of the present disclosure are applicable are given here, and in actual applications, more communication scenarios in which the power consumption of the terminal device is large due to the CDRX being in the unconfigured state may be involved.

In view of this, the embodiments of the present disclosure provide a solution for communication control. In the solution according to the embodiments of the present disclosure, a state of CDRX between a terminal device and a network device is first determined. If the state indicates that the CDRX is in an unconfigured state, whether to trigger a reconnection is determined based on at least one of a duration of the unconfigured state of the CDRX or a data transceiving condition of the terminal device. Further, if it is determined to trigger the reconnection, a reconnection operation between the terminal device and the network device is triggered.

In this way, during the communication process between the terminal device and the network device, in a case where the terminal device determines that the CDRX between the terminal device and the network device is in the unconfigured state, the reconnection operation between the terminal device and the network device is triggered, which may trigger the network device to restore the configuration of the CDRX of the terminal device. In this way, the problem of increased power consumption of the terminal device caused by the CDRX being in the unconfigured state may be solved, especially for the terminal device with occasional intensive data transceiving, the power consumption of this type of terminal device may be reduced while ensuring a good data communication effect.

Various example implementations of this solution are described in detail below with further reference to the drawings.

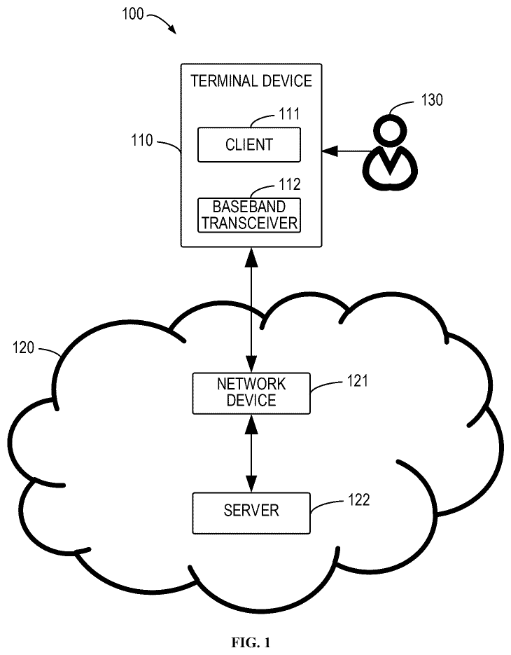

FIG. 1 shows a schematic diagram of an example environment 100 in which the embodiments of the present disclosure may be implemented. As shown in FIG. 1, the example environment 100 may include a terminal device 110 and a user 130. The terminal device 110 may be any type of mobile terminal, fixed terminal or portable terminal with communication capability, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/video camera, a positioning device, a TV receiver, a radio broadcast receiver, an e-book device, a game device, or any combination of the foregoing, including the accessories and peripherals of these devices or any combination thereof. In some embodiments, the terminal device 110 may also support any type of interface for the user 130 (such as a “wearable” circuit, etc.). The terminal device 110 may be any type of single terminal device or a combination of multiple terminal devices, including the accessories and peripherals of the devices or any combination thereof.

In this example environment 100, the terminal device 110 may be run with a client 111 and a baseband transceiver 112. As an example, the client 111 may correspond to an operating system of the terminal device 110. As another example, the client 111 may correspond to any type of applications installed on the terminal device 110. The applications may be any suitable type of applications that may be run by the terminal device 110, examples of which may include but are not limited to social applications, game applications, or other suitable applications. The user 130 may interact with the applications via the terminal device 110 and/or its attached devices. The baseband transceiver 112 may be used to send and receive data to and from a network device 121 of a network 120.

The network 120 for communication control may provide any communication services required by the user 130, including voice calls, video calls, SMS and MMS services, data Internet services, and so on. In this example environment 100, the network device 121 of the network 120 may send and receive data to and from the baseband transceiver 112 of the terminal device 110, and the network device 121 may be connected to a server 122. The communication between the terminal device 110 and the network device 121 may be implemented according to any appropriate communication protocol(s). Examples of communication protocols include, but are not limited to, first generation (1G), second generation (2G), 2.5G, 2.75G, third generation (3G), fourth generation (4G), 4.5G, fifth generation (5G), sixth generation (6G) and other cellular communication protocols, wireless local area network communication protocols such as the Institute of Electrical and Electronics Engineers (IEEE) 802.11, and/or any other protocols currently known or to be developed in the future.

The server 122 may be an independent physical server, a server cluster or a distributed system comprising multiple physical servers, or may be a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms. The server 122 may include, for example, a computing system/server, such as a mainframe, an edge computing node, a computing device in a cloud environment, and so on. The server 122 may perform data processing to provide a communication service in response to user needs.

It should be understood that the structure and function of each element in the environment 100 are described only for the purpose of illustration, and do not imply any limitation to the scope of the present disclosure.

Some example embodiments of the present disclosure will be described below with continued reference to the drawings.

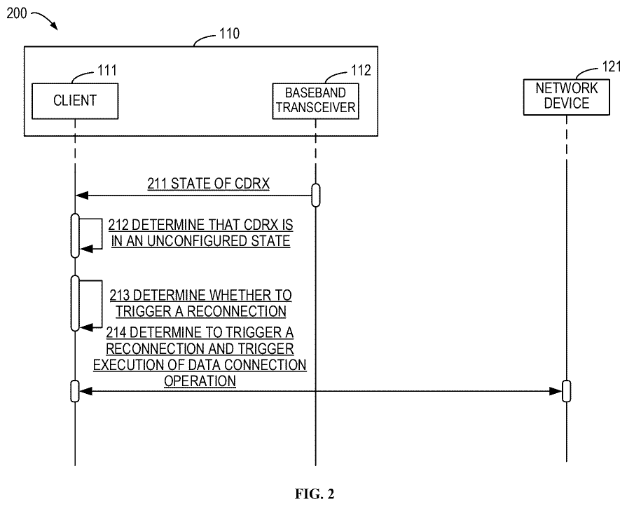

FIG. 2 to FIG. 3 show flowcharts of example communication control processes 200 and 300 according to some embodiments of the present disclosure. The communication control processes 200 and 300 may be implemented based on the environment 100 shown in FIG. 1. The data communication processes shown in FIG. 2 and FIG. 3 are described below in conjunction with FIG. 1.

As shown in FIG. 2, during a process of the terminal device 110 communicating with the network 120, the baseband transceiver 112 of the terminal device 110 may receive a state configuration of the CDRX for the terminal device 110 from the network device 121. The state configuration may configure the terminal device 110 to operate in the CDRX mode or not in the CDRX mode.

In the embodiments of the present disclosure, the baseband transceiver 112 sends (211) the state of the CDRX between the terminal device 110 and the network device 121 to the client 111 of the terminal device 110. The state of the CDRX between the terminal device 110 and the network device 121 may include a configured state and an unconfigured state. If the CDRX is in the configured state, it may indicate that the terminal device 110 is allowed to periodically enter a sleep state when the terminal device 110 maintains a communication connection with the network device 121. In the sleep state of the CDRX, the terminal device 110 may not monitor a physical downlink control channel (PDCCH) from the network device 121, thereby reducing the power consumption of the terminal device 110. If the terminal device 110 needs to receive downlink data or send uplink data, the terminal device 110 may also wake up from the sleep state to an awake state, so that the terminal device 110 may perform normal data transceiving operations. In the embodiments of the present disclosure, the CDRX being in the unconfigured state indicates that the network device 121 does not configure the CDRX or the configuration information of the CDRX is incorrect. If the CDRX is in the unconfigured state and the terminal device 110 performs data transceiving with low activity, the terminal device 110 cannot enter the sleep state at this time, which in turn leads to high power consumption of the terminal device 110 and reduces the usage time of the terminal device 110.

As an example, for a specific communication process between the terminal device 110 and the network device 121, reference may be made to FIG. 3. As shown in FIG. 3, if the client 111 determines that the terminal device 110 is to communicate with the network device 121, the client 111 may establish (311) a communication connection. After receiving the notification of establishing a communication connection from the client 111, the baseband transceiver 112 may first establish (312) a protocol data unit (PDU)/packet data network (PDN) connection. As a data unit exchanged between different hierarchical levels in a communication protocol stack, the PDU may implement data encapsulation, transmission and decapsulation. The PDN is an external data network accessed by the terminal device 110 during the communication. It may be understood that the PDU/PDN connection may provide the terminal device 110 with a channel to access the external data network.

Continuing to refer to FIG. 3, after establishing (312) the PDU/PDN connection, the baseband transceiver 112 then establishes (313) an RRC connection between the terminal device 110 and the network device 121 of the network 120. The RRC connection is a channel for data transmission between the terminal device 110 and the network device 121 during the communication. The RRC connection may ensure effective data transmission between the terminal device 110 and the network device 121. After the RRC connection is established, the network device 112 may configure CDRX information and send (314) a state of the CDRX between the terminal device 110 and the network device 121 to the terminal device 110. The baseband transceiver 112 of the terminal device 110 may receive the state of the CDRX sent by the network device 121 and send (315) the state of the CDRX to the client 111 of the terminal device 110.

Further, if the client 111 determines (316) that the CDRX between the terminal device 110 and the network device 121 is in the configured state, normal data transceiving (317) may be performed with the network device 121. It may be understood that when the CDRX is configured, data transceiving with low activity may be performed between the terminal device 110 and the network device 121. For example, when the number of applications in an active state (or referred to as a usage state) in the terminal device 110 is less than a number threshold, the terminal device 110 may be in a data transceiving state with low activity. As an example communication scenario, assuming that the number threshold is 1, if the terminal device 110 is in a pure desktop state, or if there is no application in an active state in the terminal device 110, the terminal device 110 may perform data transceiving with low activity. For another example, when a data throughput rate of the terminal device 110 is lower than a rate threshold, the terminal device 110 may be in a data transceiving state with low activity. As an example communication scenario, the terminal device 110 uses a 4G network to communicate. If the data throughput rate of the terminal device 110 is lower than the rate threshold of 1 MB/s, the terminal device 110 may perform data transceiving with low activity.

Similarly, depending on specific needs, the terminal device 110 and the network device 121 may also need to perform data transceiving with high activity. For example, when the number of applications in an active state (or referred to as a usage state) in the terminal device 110 is equal to or greater than a number threshold, the terminal device 110 may be in a data transceiving state with high activity. As an example communication scenario, assuming that the number threshold is 1, if there are 5 applications in the active state in the terminal device 110, the terminal device 110 may perform data transceiving with high activity. For another example, when a data throughput rate of the terminal device 110 is equal to or higher than a rate threshold, the terminal device 110 may be in a data transceiving state with high activity. As an example communication scenario, the terminal device 110 uses a 5G network to communicate. If the data throughput rate of the terminal device 110 is higher than the rate threshold of 10 MB/s, the terminal device 110 may perform data transceiving with high activity. It may be understood that the size of the parameters (for example, the above-mentioned number threshold and rate threshold) may be adjusted according to the communication network adaptability of the terminal device 110. For example, a higher number threshold and/or rate threshold may be set for the 5G network than for the 4G network. It should be understood that only example communication scenarios involving data transceiving with low/high activity are given here, and in actual applications, more, less or other communication scenarios may be considered according to the data transceiving conditions.

Continuing to refer to FIG. 3, if data transceiving with high activity is performed between the terminal device 110 and the network device 121, or high-speed data transmission is performed between the terminal device 110 and the network device 121, it is possible that the network device 121 does not reconfigure the CDRX after the high-speed data transmission ends. In this case, the network device 121 sends (318) to the terminal device 110 that the state of the CDRX between the terminal device 110 and the network device 121 indicates that the CDRX is in the unconfigured state. Next, the baseband transceiver 112 of the terminal device 110 receives the state of the CDRX sent by the network device 121 and sends (211) the received state of the CDRX to the client 111.

Referring back to FIG. 2, the client 111 determines (212) that the CDRX is in the unconfigured state based on the received state of the CDRX. Further, the client 111 determines (213) whether to trigger a reconnection between the terminal device 110 and the network device 121 based on at least one of a duration of the unconfigured state of the CDRX or a data transceiving condition of the terminal device 110.

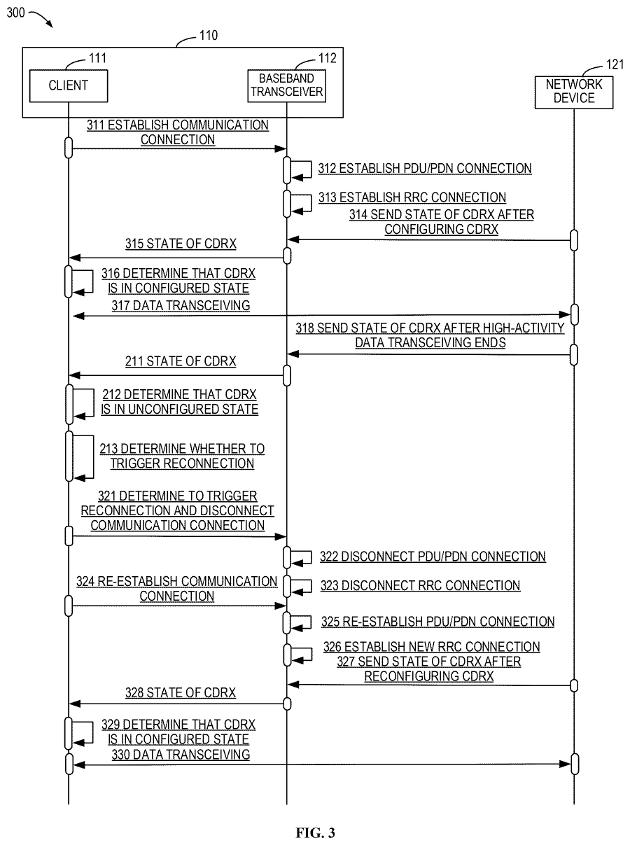

FIG. 4 shows a flowchart of an example process 400 of determining to trigger a reconnection according to some embodiments of the present disclosure. The process 400 may be considered as an example embodiment of operation 213 in FIG. 2 and FIG. 3.

As shown in FIG. 4, at block 410, the client 111 determines, based on the received state of the CDRX, that the CDRX of the terminal device 110 is in the unconfigured state. In the next period of time, at block 420, the client 111 may continue to determine whether the CDRX of the terminal device 110 is still in the unconfigured state. This is because that the CDRX may be in the unconfigured state due to a high-activity data transceiving requirement between the terminal device 110 and the network device 121, but such a high-speed data transceiving requirement usually does not last too long. At block 430, if the client 111 determines that the CDRX of the terminal device 110 is in the configured state, that is, the CDRX configured state has been restored, the current process 400 of determining to trigger the reconnection may be exited.

At block 440, if the client 111 determines that the CDRX is still in the unconfigured state (for example, the duration exceeds a threshold), it continues to determine whether the data throughput rate of the terminal device 110 is lower than a rate threshold. If the client 111 determines that the data throughput rate of the terminal device 110 is equal to or higher than the rate threshold, it restarts to determine whether the CDRX is still in the unconfigured state. At block 450, if the client 111 determines that the data throughput rate of the terminal device 110 is lower than the rate threshold, it may increase the count of a waiting counter by 1, and may execute block 460 after waiting for a predetermined time (for example, 10 s).

At block 460, the client 111 may determine whether the count of the waiting counter is greater than a predetermined value (for example, 2). If the client 111 determines that the count of the waiting counter is equal to or less than the predetermined value (for example, 2), it returns to block 420 again to determine whether the CDRX is continuously in the unconfigured state, etc. If it is determined that the count of the waiting counter is greater than the predetermined value (for example, 2), at block 470, the client 111 may determine to trigger the reconnection operation between the terminal device 110 and the network device 121.

That is, based on the example process 400 of FIG. 4, the client 111 may determine to trigger the reconnection when determining that the duration of the CDRX being in the unconfigured state reaches a preset duration (for example, 30 s) and the data throughput rate of the terminal device 110 continues to be lower than the rate threshold within the preset duration.

It may be understood that the above parameters such as the predetermined time and the predetermined value related to the waiting counter may be arbitrarily configured according to actual needs, and the above description is only an example. It should be understood that the process 400 shown in FIG. 4 is only an example flow of determining whether to trigger the reconnection, and in actual applications, more, less or other communication information may be considered as needed to determine whether to trigger the reconnection operation between the terminal device 110 and the network device 121.

Referring back to FIG. 2, if the client 111 determines to trigger the reconnection, the reconnection operation between the terminal device 110 and the network device 121 is triggered (214) to be performed.

FIG. 3 also specifically shows an example of the reconnection operation between the terminal device 110 and the network device 121. As shown in FIG. 3, if the client 111 determines to trigger the reconnection, the communication connection with the network device 121 may first be disconnected (321). After receiving the notification of disconnecting the communication connection from the client 111, the baseband transceiver 112 may first disconnect (322) the PDU/PDN connection, and then disconnect (323) the RRC connection between the terminal device 110 and the network device 121.

Further, the client 111 may re-establish (324) the communication connection between the terminal device 110 and the network device 121. Similarly, after receiving the notification of re-establishing the communication connection from the client 111, the baseband transceiver 112 may re-establish (325) the PDU/PDN connection, and then establish (326) a new RRC connection between the terminal device 110 and the network device 121. The network device 121 reconfigures the CDRX information based on the notification of establishing the new RRC connection. And the network device 121 may send (327) the reconfigured state of the CDRX to the terminal device 110. Similarly, after receiving the state of the CDRX corresponding to the new RRC connection, the baseband transceiver 112 sends (328) the state of the CDRX to the client 111.

The network device 121 may re-determine whether to configure CDRX for the terminal device 110 based on the new RRC connection established by the terminal device 110. If at this time the terminal device 110 does not have a data communication requirement with a high data throughput, the network device 121 may configure CDRX for the terminal device 110. In this case, the baseband transceiver 112 of the terminal device 110 may notify the client device 111 that the CDRX is in the configured state. Therefore, after receiving the state of the CDRX corresponding to the new RRC connection, the client 111 may determine (329) that the CDRX is in the configured state. In the subsequent process, the terminal device 110 may continue to perform data transceiving (330) with the network device 121 in the CDRX mode, which may save device power overhead.

As may be seen from the above multiple embodiments, the embodiments of the present disclosure may at least achieve sending the state of the CDRX between the terminal device 110 and the network device 121 to the terminal device 110, and the terminal device 110 may initiate a detection process of whether to trigger the reconnection when determining that the CDRX is in the unconfigured state. If the terminal device 110 detects and determines that the reconnection needs to be triggered, the reconnection operation between the terminal device 110 and the network device 121 may be triggered to be performed, so that the CDRX between the terminal device 110 and the network device 121 is in a normal configured state, thereby ensuring that while the terminal device 110 and the network device 121 perform normal data transceiving, the CDRX is adjusted to enter the sleep state or the awake state based on the data transceiving situation between the terminal device 110 and the network device 121, so as to reduce the power consumption of the terminal device 110 and prolong the usage time of the terminal device 110.

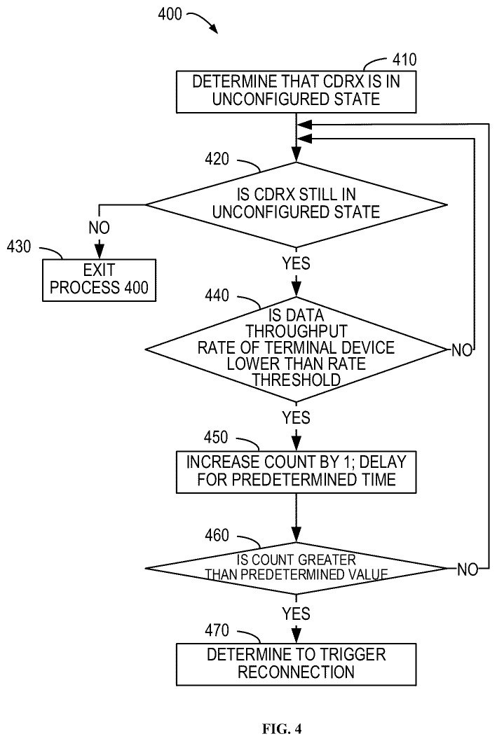

FIG. 5 shows a flowchart of an example process 500 of communication control according to some embodiments of the present disclosure. The process 500 may be implemented at terminal device 110. The process 500 is described below with reference to FIG. 1.

As shown in FIG. 5, at block 510, the terminal device 110 determines a state of connected mode discontinuous reception (CDRX) between the terminal device and a network device.

At block 520, the terminal device 110 determines whether to trigger a reconnection based on at least one of a duration of the unconfigured state of the CDRX or a data transceiving condition of the terminal device, in response to the state indicating that the CDRX is in an unconfigured state.

At block 530, the terminal device 110 triggers a reconnection operation between the terminal device 110 and the network device, in response to determining to trigger the reconnection.

In some embodiments, a notification of the state of the CDRX is received from the baseband transceiver 112 of the terminal device 110, where the baseband transceiver 112 is configured to perform data transceiving with the network device 121.

In some embodiments, the terminal device 110 determines a further state of the CDRX between the terminal device 110 and the network device 121; and the terminal device 110 performs communication with the network device 121 based on configuration information of the CDRX, in response to the further state indicating that the CDRX is in a configured state.

In some embodiments, the terminal device 110 determining whether to trigger the reconnection includes: determining to trigger the reconnection based on at least one of the following: the duration of the unconfigured state of the CDRX reaching a preset duration, or the data transceiving condition of the terminal device 110 indicates that data transceiving activity being lower than an activity threshold.

In some embodiments, the terminal device 110 determines that the data transceiving condition of the terminal device 110 indicates that the data transceiving activity is lower than the activity threshold based on at least one of the following: the number of applications in an active state in the terminal device 110 being less than a number threshold, or a data throughput rate of the terminal device 110 being lower than a rate threshold.

In some embodiments, triggering the reconnection operation between the terminal device 110 and the network device 121 includes: disconnecting a communication connection between the terminal device 110 and the network device 121; and re-establishing the communication connection between the terminal device 110 and the network device 121.

In some embodiments, re-establishing the communication connection between the terminal device 110 and the network device 121 includes: receiving CDRX configuration information from the network device 121, the CDRX configuration information indicating that the CDRX of the terminal device 110 is in the configured state.

In some embodiments, the communication connection between the terminal device 110 and the network device 121 includes at least one of the following: a protocol data unit (PDU) connection, a packet data network (PDN) connection, or a radio resource control (RRC) connection.

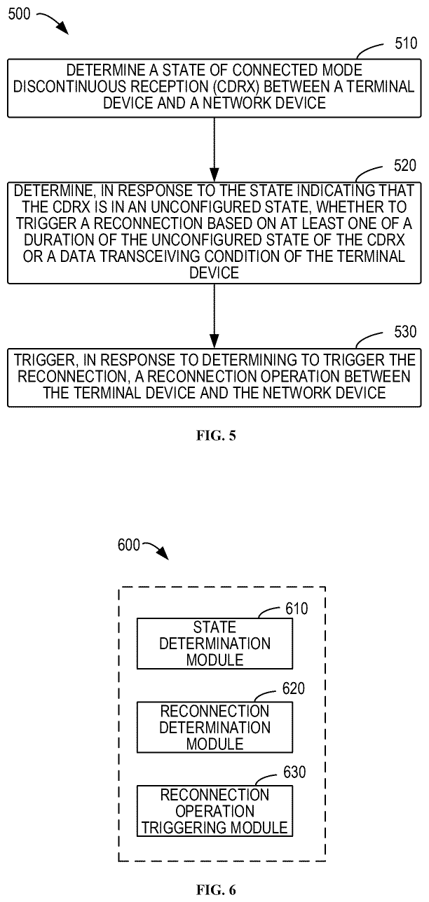

The embodiments of the present disclosure further provide a corresponding apparatus for implementing the above method or process. FIG. 6 shows a schematic structural block diagram of an example apparatus 600 for communication control according to some embodiments of the present disclosure. The apparatus 600 may be implemented as or included in the terminal device 110. Each module/component in the apparatus 600 may be implemented by hardware, software, firmware, or any combination thereof.

As shown in FIG. 6, the apparatus 600 includes: a state determination module 610 configured to determine a state of CDRX between the terminal device 110 and the network device 121; a reconnection determination module 620 configured to determine whether to trigger a reconnection based on at least one of a duration of an unconfigured state of the CDRX or a data transceiving condition of the terminal device 110, in response to the state indicating that the CDRX is in the unconfigured state; and a reconnection operation triggering module 630 configured to trigger a reconnection operation between the terminal device 110 and the network device 121, in response to determining to trigger the reconnection.

In some embodiments, the state determination module 610 may be further configured to receive a notification of the state of the CDRX from the baseband transceiver 112 of the terminal device 110, where the baseband transceiver 112 is configured to perform data transceiving with the network device 121.

In some embodiments, the apparatus 600 further includes: a communication determination module configured to determine, by the terminal device 110, a further state of the CDRX between the terminal device 110 and the network device 121; and perform, by the terminal device 110, communication with the network device 121 based on configuration information of the CDRX, in response to the further state indicating that the CDRX is in a configured state.

In some embodiments, the reconnection determination module 620 may be further configured to determine to trigger the reconnection based on at least one of the following: the duration of the unconfigured state of the CDRX reaching a preset duration, or the data transceiving condition of the terminal device 110 indicates that data transceiving activity being lower than an activity threshold.

In some embodiments, the reconnection determination module 620 may be further configured to determine that the data transceiving condition of the terminal device 110 indicates that the data transceiving activity is lower than the activity threshold based on at least one of the following: the number of applications in an active state in the terminal device 110 being less than a number threshold, or a data throughput rate of the terminal device 110 being lower than a rate threshold.

In some embodiments, the reconnection operation triggering module 630 may be further configured to disconnect a communication connection between the terminal device 110 and the network device 121; and re-establish the communication connection between the terminal device 110 and the network device 121.

In some embodiments, the reconnection operation triggering module 630 may be further configured to receive CDRX configuration information from the network device 121, the CDRX configuration information indicating that the CDRX of the terminal device 110 is in the configured state.

In some embodiments, the communication connection between the terminal device 110 and the network device 121 includes at least one of the following: a protocol data unit (PDU) connection, a packet data network (PDN) connection, or a radio resource control (RRC) connection.

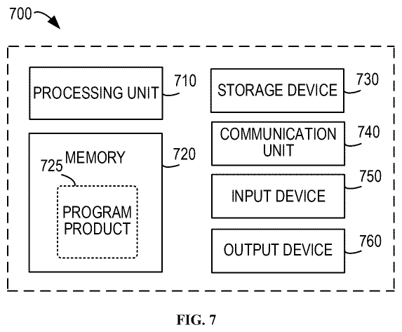

FIG. 7 shows a block diagram of an electronic device 700 capable of implementing multiple embodiments of the present disclosure. As shown in FIG. 7, the electronic device 700 is in the form of a general-purpose electronic device. The components of the electronic device 700 may include, but are not limited to, one or more processors or processing units 710, a memory 720, a storage device 730, one or more communication units 740, one or more input devices 750, and one or more output devices 760. The processing unit 710 may be an actual or virtual processor and may execute various processes based on the program stored in the memory 720. In a multi-processor system, multiple processing units execute computer-executable instructions in parallel to improve the parallel processing capability of the electronic device 700.

The electronic device 700 typically includes multiple computer storage medium. Such medium may be any available medium that is accessible to the electronic device 700, including, but not limited to, volatile and non-volatile medium, removable and non-removable medium. The memory 720 may be a volatile memory (for example, a register, cache, a random access memory (RAM)), a non-volatile memory (such as a read-only memory (ROM), an electrically erasable programmable read-only memory (EEPROM), a flash memory), or any combination thereof. The storage device 730 may be any removable or non-removable medium, and may include a machine-readable medium such as a flash drive, a disk, or any other medium, which may be used to store information and/or data and may be accessed within the electronic device 700.

The electronic device 700 may further include additional removable/non-removable, volatile/non-volatile memory medium. Although not shown in FIG. 7, a disk driver for reading from or writing to a removable, non-volatile disk (such as a “floppy disk”), and an optical disk driver for reading from or writing to a removable, non-volatile optical disk may be provided. In these cases, each driver may be connected to the bus (not shown) by one or more data medium interfaces. The memory 720 may include a computer program product 725, which has one or more program modules configured to perform various methods or acts of various embodiments of the present disclosure.

The communication unit 740 implements communication with other electronic devices through the communication medium. Additionally, the functions of the components of the electronic device 700 may be implemented by a single computing cluster or multiple computing machines, which may communicate through communication connections. Therefore, the electronic device 700 may use a logical connection with one or more other servers, network personal computers (PCs) or another network node to operate in a networked environment.

The input device 750 may be one or more input devices, such as a mouse, a keyboard, a tracking ball, etc. The output device 760 may be one or more output devices, such as a display, a speaker, a printer, etc. The electronic device 700 may also communicate with one or more external devices (not shown) such as a storage device, a display device, etc., with one or more devices that enable the user to interact with the electronic device 700, or with any devices (e.g., a network card, a modem, etc.) that enable the electronic device 700 to communicate with one or more other electronic devices, as needed, through the communication unit 740. Such communication may be performed via input/output (I/O) interfaces (not shown).

According to an example implementation of the present disclosure, there is provided a computer-readable storage medium having computer-executable instructions stored thereon, where the computer-executable instructions are executed by a processor to implement the method described above. According to an example implementation of the present disclosure, there is further provided a computer program product tangibly stored on a non-transitory computer-readable medium and including computer-executable instructions, which are executed by a processor to implement the method described above.

Various aspects of the present disclosure are described herein with reference to flowcharts and/or block diagrams of methods, apparatuses, devices and computer program products implemented according to the present disclosure. It should be understood that each block of the flowcharts and/or block diagrams, and combinations of blocks in the flowcharts and/or block diagrams, may be implemented by computer-readable program instructions.

These computer-readable program instructions may be provided to a processing unit of a general-purpose computer, a special-purpose computer, or other programmable data processing apparatus to produce a machine, such that these instructions, when executed by the processing unit of the computer or other programmable data processing apparatus, produce an apparatus for implementing the functions/acts specified in one or more blocks of the flowcharts and/or block diagrams. These computer-readable program instructions may also be stored in a computer-readable storage medium, these instructions cause the computer, the programmable data processing apparatus, and/or other devices to work in a specific manner, so that the computer-readable medium storing the instructions includes a manufactured product, which includes instructions for implementing various aspects of the functions/acts specified in one or more blocks of the flowcharts and/or block diagrams.

The computer-readable program instructions may be loaded onto a computer, other programmable data processing apparatus, or other devices, so that a series of operation steps are performed on the computer, other programmable data processing apparatus, or other devices to produce a computer-implemented process, so that the instructions executed on the computer, other programmable data processing apparatus, or other devices implement the functions/acts specified in one or more blocks of the flowcharts and/or block diagrams.

The flowcharts and block diagrams in the drawings show the possibly implemented architectures, functions and operations of the system, the method and the computer program product according to multiple implementations of the present disclosure. In this regard, each block in the flowchart or block diagram may represent a module, program segment, or part of an instruction, and the module, program segment, or part of an instruction contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagram and/or the flowchart, and the combination of the blocks in the block diagram and/or the flowchart may be implemented by a dedicated hardware-based system that executes specified functions or acts, or by a combination of dedicated hardware and computer instructions.

The implementations of the present disclosure have been described above, and the above description is for example, not exhaustive, and is not limited to the disclosed implementations. Without departing from the scope and spirit of the described implementations, many modifications and changes will be apparent to those of ordinary skill in the art. The choice of terms used herein is intended to best explain the principles, practical applications, or improvements to the technology in the market of the implementations, or to enable other ordinary skilled persons in the art to understand the implementations disclosed herein.

1. A communication control method implemented at a terminal device, comprising:
determining a state of connected mode discontinuous reception (CDRX) between the terminal device and a network device;
determining, in response to the state indicating that the CDRX is in an unconfigured state, whether to trigger a reconnection based on at least one of a duration of the unconfigured state of the CDRX or a data transceiving condition of the terminal device; and
triggering, in response to determining to trigger the reconnection, a reconnection operation between the terminal device and the network device.

2. The method of claim 1, wherein determining the state of the CDRX of the terminal device comprises:
receiving a notification of the state of the CDRX from a baseband transceiver of the terminal device, wherein the baseband transceiver is configured to perform data transceiving with the network device.

3. The method of claim 1, further comprising:
determining a further state of the CDRX between the terminal device and the network device; and
performing, in response to the further state indicating that the CDRX is in a configured state, communication between the terminal device and the network device based on configuration information of the CDRX.

4. The method of claim 1, wherein determining whether to trigger the reconnection comprises:
determining to trigger the reconnection based on at least one of the following:
the duration of the unconfigured state of the CDRX reaching a preset duration, or
the data transceiving condition of the terminal device indicating that data transceiving activity is lower than an activity threshold.

5. The method of claim 4, wherein the data transceiving condition of the terminal device indicating that the data transceiving activity is lower than the activity threshold is determined based on at least one of the following:
a number of applications in an active state in the terminal device being less than a number threshold, or
a data throughput rate of the terminal device being lower than a rate threshold.

6. The method of claim 1, wherein triggering the reconnection operation between the terminal device and the network device comprises:
disconnecting a communication connection between the terminal device and the network device; and
re-establishing the communication connection between the terminal device and the network device.

7. The method of claim 6, wherein re-establishing the communication connection between the terminal device and the network device comprises:
receiving CDRX configuration information from the network device, the CDRX configuration information indicating that the CDRX of the terminal device is in a configured state.

8. The method of claim 6, wherein the communication connection between the terminal device and the network device comprises at least one of the following:
a protocol data unit (PDU) connection,
a packet data network (PDN) connection, or
a radio resource control (RRC) connection.

9. An electronic device, comprising:
at least one processor; and
at least one memory, the at least one memory coupled to the at least one processor and storing instructions for execution by the at least one processor, the instructions, when executed by the at least one processor, causing the electronic device to perform acts comprising:
determining a state of connected mode discontinuous reception (CDRX) between a terminal device and a network device;
determining, in response to the state indicating that the CDRX is in an unconfigured state, whether to trigger a reconnection based on at least one of a duration of the unconfigured state of the CDRX or a data transceiving condition of the terminal device; and
triggering, in response to determining to trigger the reconnection, a reconnection operation between the terminal device and the network device.

10. The electronic device of claim 9, wherein determining the state of the CDRX of the terminal device comprises:
receiving a notification of the state of the CDRX from a baseband transceiver of the terminal device, wherein the baseband transceiver is configured to perform data transceiving with the network device.

11. The electronic device of claim 9, the acts further comprising:
determining a further state of the CDRX between the terminal device and the network device; and
performing, in response to the further state indicating that the CDRX is in a configured state, communication between the terminal device and the network device based on configuration information of the CDRX.

12. The electronic device of claim 9, wherein determining whether to trigger the reconnection comprises:
determining to trigger the reconnection based on at least one of the following:
the duration of the unconfigured state of the CDRX reaching a preset duration, or
the data transceiving condition of the terminal device indicating that data transceiving activity is lower than an activity threshold.

13. The electronic device of claim 12, wherein the data transceiving condition of the terminal device indicating that the data transceiving activity is lower than the activity threshold is determined based on at least one of the following:
a number of applications in an active state in the terminal device being less than a number threshold, or
a data throughput rate of the terminal device being lower than a rate threshold.

14. The electronic device of claim 9, wherein triggering the reconnection operation between the terminal device and the network device comprises:
disconnecting a communication connection between the terminal device and the network device; and
re-establishing the communication connection between the terminal device and the network device.

15. The electronic device of claim 14, wherein re-establishing the communication connection between the terminal device and the network device comprises:
receiving CDRX configuration information from the network device, the CDRX configuration information indicating that the CDRX of the terminal device is in a configured state.

16. The electronic device of claim 14, wherein the communication connection between the terminal device and the network device comprises at least one of the following:
a protocol data unit (PDU) connection,
a packet data network (PDN) connection, or
a radio resource control (RRC) connection.

17. A non-transitory computer-readable storage medium having a computer program stored thereon, the computer program being executable by a processor to implement acts comprising:
determining a state of connected mode discontinuous reception (CDRX) between a terminal device and a network device;
determining, in response to the state indicating that the CDRX is in an unconfigured state, whether to trigger a reconnection based on at least one of a duration of the unconfigured state of the CDRX or a data transceiving condition of the terminal device; and
triggering, in response to determining to trigger the reconnection, a reconnection operation between the terminal device and the network device.

18. The non-transitory computer-readable storage medium of claim 17, wherein determining the state of the CDRX of the terminal device comprises:
receiving a notification of the state of the CDRX from a baseband transceiver of the terminal device, wherein the baseband transceiver is configured to perform data transceiving with the network device.

19. The non-transitory computer-readable storage medium of claim 17, the acts further comprising:
determining a further state of the CDRX between the terminal device and the network device; and
performing, in response to the further state indicating that the CDRX is in a configured state, communication between the terminal device and the network device based on configuration information of the CDRX.

20. The non-transitory computer-readable storage medium of claim 17, wherein determining whether to trigger the reconnection comprises:
determining to trigger the reconnection based on at least one of the following:
the duration of the unconfigured state of the CDRX reaching a preset duration, or
the data transceiving condition of the terminal device indicating that data transceiving activity is lower than an activity threshold.
